(19) United States
(12) Patent Application Publication
(10) Pub. No.: US 2021/0256447 A1
(43) Pub. Date: Aug. 19, 2021

(54) DETECTION FOR AI-BASED RECOMMENDATION

(71) Applicant: International Business Machines Corporation, Armonk, NY (US)

(72) Inventors: Lukasz G. Cmielowski, Krakow (PL); Rafal Bigaj, Krakow (PL); Maksymilian Erazmus, Zasow (PL); Wojciech Sobala, Krakow (PL)

(21) Appl. No.: 16/792,340

(22) Filed: Feb. 17, 2020

(51) Int. Cl. G06Q 10/06; G06K 9/62; G06N 20/00; G06F 17/18

(52) U.S. Cl. CPC G06Q 10/06393; G06Q 10/0637; G06F 17/18; G06N 20/00; G06K 9/628

(57) ABSTRACT

In an approach, a processor loads a set of scoring batches, each scoring batch containing multiple scoring payload records, the scoring payload records storing input data provided to an AI-based recommendation system. A processor derives quality indicators for each scoring batch from the scoring payload records. A processor aggregates the quality indicators to obtain an aggregated quality indicator, wherein the aggregated quality indicator specifies an estimated quality of recommendations by the AI-based recommendation system for each respective scoring batch. A processor adds the aggregated quality indicator to a set. A processor calculates a key performance indicator for each scoring batch. A processor adds the key performance indicator to a set. A processor determines that a degree of correlation between the set of aggregated quality indicators and the set of key performance indicators is within a predefined range. A processor generates a notification that the AI-based recommendation system has been ignored.

### BACKGROUND

The present invention relates generally to the field of artificial intelligence (AI) based recommendations, and more particularly to detecting whether recommendations by an AI-based recommendation system have been ignored.

The term artificial intelligence (AI) generally refers to intelligent behavior shown by computing devices. The implementation of intelligent behavior by machines may be achieved in various ways, for instance by means of artificial neural networks or statistical methods. Computing systems which exhibit artificial intelligence may be employed in a wide range of fields. One possible application lies in the field of recommendation systems. A recommendation system may receive one or more input values. The recommendation system analyzes the input values and provides an appropriate recommendation.

AI-based systems can be used to provide advice in the context of business processes. A business process comprises a collection of tasks which are necessary for providing a service or producing a product. Software may help to organize and analyze business processes, and furthermore, business processes may be partially automatized. For instance, AI-based recommendation systems may provide recommendations for various business decisions. This allows to improve business-related decisions.

In the field, Explaining Differences Between Predicted Outcomes and Actual Outcomes of a Process describe “[m]ethods for analyzing and rendering business intelligence data allow for efficient scalability as datasets grow in size. Human intervention is minimized by augmented decision making ability in selecting what aspects of large datasets should be focused on to drive key business outcomes. Variable value combinations that are predominant drivers of key observations are automatically determined from several competing variable value combinations. The identified variable value combinations can then be then used to predict future trends underlying the business intelligence data. In another embodiment, an observed outcome is decomposed into multiple contributing drivers and the impact of each of the contributing drivers can be analyzed and numerically quantified—as a static snapshot or as a time-varying evolution. Similarly, differences in observations between two groups can be decomposed into multiple contributing sub-groups for each of the groups and pairwise differences among sub-groups can be quantified and analyzed.” (US 2018/0293502, Abstract). Methods of Predicting Project Outcomes describes “a method and system for predicting project outcomes. The present method and system for predicting project outcomes aids a project manager or CEO in quickly determining if projects are on track to be completed as scheduled, and what areas or personnel need assistance in meeting their project goals and deadlines.” (US 2018/0211195, Abstract).

AI-based recommendation systems have proven to be very helpful in practice, providing accurate advice and reducing the risk of human error. While many aspects of various processes can be automated, some steps may still need to be performed manually. For instance, actions such as drafting a contract or executing a purchase order are usually performed by human operators. Due to oversight, or even on purpose, a human operator may not follow recommendations by an AI-based recommendation system. This may lead to significant monetary losses.

### SUMMARY

Various embodiments provide a method for detecting whether recommendations by an AI-based recommendation system for a process have been ignored. Further embodiments provide a computing system capable of detecting whether recommendations by an AI-based recommendation system for a process have been ignored. Further embodiments provide a computer program product for operating a computing system capable of detecting whether recommendations by an AI-based recommendation system for a process have been ignored. Advantageous embodiments are described in the dependent claims. Embodiments of the present invention can be freely combined with each other if they are not mutually exclusive.

In one aspect, an embodiment of the invention relates to a method. A processor loads a set of scoring batches, each scoring batch containing multiple scoring payload records, the scoring payload records storing input data provided to an artificial intelligence (AI) based recommendation system in response to the input data. A processor derives quality indicators for each scoring batch from the scoring payload records. A processor aggregates the quality indicators to obtain an aggregated quality indicator, where the aggregated quality indicator specifies an estimated quality of recommendations by the AI-based recommendation system for each respective scoring batch. A processor adds the aggregated quality indicator to a set of aggregated quality indicators. A processor calculates a key performance indicator for each scoring batch. A processor adds the key performance indicator to a set of key performance indicators. A processor determines that a degree of correlation between the set of aggregated quality indicators and the set of key performance indicators is within a predefined range. A processor, responsive to the degree of correlation being within the predefined range, generates a notification that the AI-based recommendation system has been ignored. One advantage of this approach is that one can detect whether recommendations by an AI-based recommendation system have been ignored or utilized.

In a further optional aspect, an embodiment of the invention relates to a method that further includes a processor calculating the degree of correlation by calculating a Pearson correlation coefficient between the set of key performance indicators and the set of aggregated quality indicators, wherein the predefined range is a Pearson correlation coefficient larger than −0.1 and smaller than 0.1. One advantage of this approach is that the degree of correlation can be known to be within a predefined range of a Pearson correlation.

In a further optional aspect, an embodiment of the invention includes that the key performance indicators characterize a performance of a process during disjoint time periods, each time period being associated with one scoring batch from the set of scoring batches. One advantage of this approach is that the performance of a process is characterized during disjoint time periods.

In a further optional aspect, an embodiment of the invention relates to a method that further includes a processor collecting performance data values related to a process. A processor calculates the key performance indicator based on the performance data values. One advantage of this approach is that the process performance data values are captured.

### BRIEF DESCRIPTION OF THE DRAWINGS

FIG. 1 depicts a block diagram featuring a computing system, in accordance with an embodiment of the present invention.

FIG. 2 depicts a data flow diagram illustrating how data from a scoring database and a business database may be processed and correlated, in accordance with an embodiment of the present invention.

FIG. 3 depicts a block diagram illustrating scoring batches and business batches, in accordance with an embodiment of the present invention.

FIG. 4 depicts a flowchart detailing the operation of a detection system, in accordance with an embodiment of the present invention.

FIG. 5 depicts a flowchart detailing how scoring payload records containing recommendations which have been ignored can be identified via a graphical user interface, in accordance with an embodiment of the present invention.

FIG. 6 depicts a flowchart detailing an approach for identifying via a graphical user interface scoring payload records containing recommendations which have been ignored, in accordance with an embodiment of the present invention.

FIG. 7 depicts a flowchart detailing how performance data values related to recommendations which have been ignored can be identified via a graphical user interface, in accordance with an embodiment of the present invention.

### DETAILED DESCRIPTION

The descriptions of the various embodiments of the present invention are being presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various embodiments relate to an approach for detecting whether recommendations by an AI-based recommendation system for a business process have been ignored. AI-based recommendation systems may provide assistance for business processes. In particular, AI-based recommendation systems may provide support for making business decisions. According to an embodiment, recommendations may be provided in the context of pricing, for instance when determining purchase prices or sales prices. According to another embodiment, recommendations may be provided when choosing between multiple options, for instance when deciding from which vendor to purchase a certain good or service. Recommendations may also be provided in other scenarios.

AI-based recommendation systems have proven to be very helpful in practice, providing accurate advice and reducing the risk of human error. While many aspects of business processes can be automatized, some steps may still need to be performed manually. For instance, actions such as drafting a contract or executing a purchase order are usually performed by human operators. Due to oversight or even on purpose, a human operator may not follow recommendations by an AI-based recommendation system. This may lead to significant monetary losses. Therefore, herein is presented an approach for detecting whether recommendations by an AI-based recommendation system for a business process have been ignored.

The approach comprises loading a set of scoring batches, each scoring batch containing multiple scoring payload records, the scoring payload records storing input data provided to the AI-based recommendation system and recommendation data provided by the AI-based recommendation system in response to the input data. According to embodiments, each scoring batch may contain a set of scoring payload records created within a certain time span, for instance within a day. According to an embodiment, each scoring batch may contain scoring payload records related to only one type of business decision, for instance, providing an estimate for an appropriate maximum purchase price. According to other embodiments, each scoring batch may contain scoring payloads records related to various types of business decisions, for instance, providing an estimate for an appropriate maximum purchase price and providing a recommendation from which vendor to purchase a certain product.

For each scoring batch from the set of scoring batches, quality indicators are derived from the scoring payload records. The quality indicators can be used to estimate whether the recommendations provided by the AI-based recommendation system are correct. According to embodiments, one or more quality indicators may be derived from each scoring payload record. The quality indicators are then aggregated to obtain an aggregated quality indicator, the aggregated quality indicator specifying an estimated quality of recommendations by the AI-based recommendation system for the scoring batch. The aggregated quality indicators are then added to a set of aggregated quality indicators. Therefore, given an embodiment wherein each scoring batch contains scoring payload records from one day, each aggregated quality indicator denotes an aggregated quality of recommendations from that day.

For each scoring batch from the set of scoring batches, a business key performance indicator is calculated. The business key performance indicator is a measure indicating how well a business achieves its business objectives. The business key performance indicator may be based on various data related to the business process. According to some embodiments, the business key performance indicator may be calculated by a business process management engine. Such a business process management engine may be able to partially or completely control a business process. According to other embodiments, the business key performance indicators may be calculated in another manner. The business key performance indicator is added to a set of business key performance indicators. Subsequently, a degree of correlation between the set of aggregated quality indicators and the set of business key performance indicators is calculated. If the degree of correlation between the set of business key performance indicators and the set of aggregated quality indicators is within a predefined range, a user of the AI-based recommendation system is notified that recommendations by the AI-based recommendation system have been ignored. This method may have the advantage that it allows to detect whether recommendations by the AI-based recommendation system have been ignored. The user may then take steps necessary for preventing the recommendations from being ignored again.

According to an embodiment of the invention, each scoring payload record stores multiple classes and a probability of correctness of each class, the recommendations by the AI-based recommendation system answering classification problems. This may have the advantage that a user is provided with a classification of input data, which can for instance be helpful for making business decisions. When answering classification problems, the AI-based recommendation system may receive input data and provide classes, sometimes called labels, in response. The classes may describe properties of the input data. For instance, the AI-based recommendation system may receive input values which describe medical symptoms of a patient. In this scenario, the output provided by the AI-based recommendation system may be a list of diagnoses. The AI-based recommendation system may also provide a probability of correctness for each diagnosis. In this example, each diagnosis is a class. According to one embodiment, the AI-based recommendation system may make a recommendation to the user based on a class with a highest probability of correctness. According to other embodiments, the AI-based recommendation system may provide to the user a set of classes, a probability of correctness being associated with each class.

According to embodiments, the quality indicator for each scoring payload record is derived by assembling a set of metrics comprising at least one metric selected from the group consisting of: a greatest probability of correctness stored by the scoring payload record, one subtracted by a difference between the greatest probability of correctness stored by the scoring payload record and a second greatest probability of correctness stored by the scoring payload record, one subtracted by a difference between the greatest probability of correctness stored by the scoring payload record and an average of all other probabilities of correctness stored by the scoring payload record, and a minimum number of probabilities of correctness stored by the scoring payload record that, when added up, surpass a predefined prediction interval. Deriving the quality indicators in this manner may have the advantage that the quality of recommendations can be determined based on data stored within the scoring payload records. The probability of correctness is an estimate for whether a recommendation is correct. According to embodiments, the probability of correctness is calculated by the AI-based recommendation system.

The aforementioned metrics are applicable when the AI-based recommendation system provides a solution to a classification problem. The metrics measure a degree of confidence or a degree of uncertainty with regard to a recommendation by the AI-based recommendation system. According to some embodiments, a confidence c that a recommendation is correct may be derived by choosing a greatest probability of correctness stored by the scoring payload record. For instance, when each class represents a choice, then the choice with the greatest probability of correctness PoC_{greatest} may be recommended by the AI-based recommendation system. If PoC_{greatest} is high, then a high degree of confidence c can be placed into that choice:

c=PoC_{greatest}

In order to derive a degree of uncertainty u, one may be subtracted by a difference between the greatest probability of correctness PoC_{greatest} and a second greatest probability of correctness PoC_{greatest} stored by the scoring payload record:

u=1−(PoC_{greatest}−PoC_{second greatest})

If a difference between PoC_{greatest} and PoC_{second greatest} is large, then this means that the choice with the greatest probability of correctness PoC_{greatest} is decidedly better than the second-best choice PoC_{second greatest}. In order to derive a degree of uncertainty based upon this difference, the difference is subtracted from the number one. According to another embodiment, the degree of uncertainty u is derived according to the following equation:

u=1−(PoC_{greatest}−PoC_{average})

Therein, PoC_{average} denotes an average probability of correctness calculated from all probabilities of correctness stored by the scoring payload record other than PoC_{greatest}. According to an embodiment, PoC_{average} excludes any probabilities of correctness associated with choices that fall outside of a prediction interval with a predetermined likelihood. For instance, the likelihood of the prediction interval may be set at 99%, and any probabilities associated with choices which have a likelihood smaller than 1% of being correct may be excluded.

According to other embodiments, the degree of uncertainty u may be derived by determining a minimum number of probabilities of correctness stored by the scoring payload record that, when added up, surpass a predefined prediction interval. For instance, given a predefined prediction interval of 90% and four classes A, B, C, D, with A having a probability of correctness of 60%, B having a probability of correctness of 25%, C having a probability of correctness of 9%, and D having a probability of correctness of 6%, the result for this metric is 3, as the probabilities of correctness of classes A, B, and C have to be added up in order to surpass 90%. A higher number of classes within the prediction interval implies a higher degree of uncertainty. Other metrics may be applied, as well. According to some embodiments, multiple metrics may be used in order to derive the quality indicator, and the quality indicator may therefore comprise multiple metrics. However, it is also possible that the quality indicator only consists of one metric.

According to an embodiment, the recommendations by the AI-based recommendation system answer regression problems. This may have the advantage that a user can be provided with a specific value as a recommendation. When answering a regression problem, the AI-based recommendation system provides a value from a continuous spectrum as an output. The output is dependent on input data provided to the AI-based recommendation system. Such an output may be, for instance, a recommended maximum purchase price or a recommended insurance premium.

According to some embodiments, the quality indicator for each scoring payload record is derived by assembling a set of metrics comprising at least one metric selected from the group consisting of: a difference between an upper bound and a lower bound of a prediction interval stored by the scoring payload record, a reciprocal of the difference between the upper bound and the lower bound of the prediction interval stored by the scoring payload record, a standard error of prediction stored by the scoring payload record, and a reciprocal of the standard error of prediction stored by the scoring payload record. Deriving the quality indicators in this manner may have the advantage that the quality of recommendations can be determined based on data stored within the scoring payload records. The aforementioned metrics are applicable when the AI-based system provides a solution to a regression problem. Various metrics may be employed, for instance deriving a degree of confidence c or a degree of uncertainty u. According to some embodiments, the quality indicator may comprise multiple metrics. However, it is also possible that the quality indicator only consists of one metric.

With regard to the aforementioned metrics, the difference between the lower bound and the upper of the prediction interval stored by the scoring payload record can be used to estimate whether a solution provided by the AI-based system is correct. The prediction interval specifies a range of values which contains a correct solution to the regression problem, given a predetermined likelihood. A smaller distance between the upper bound, denoted as pᵤ, and the lower bound, denoted as pₗ means that there is less room for error, yielding a degree of uncertainty u:

u=pᵤ−pₗ

In order to obtain a measure of confidence that a solution provided by the AI-based system is correct, a reciprocal of said distance may be calculated, denoting a degree of confidence c:

$$c = \frac{1}{u}$$

According to embodiments, the prediction interval is provided by the AI-based system and stored within the corresponding scoring payload record. According to other embodiments, the prediction interval may be obtained from other sources.

With regard to the aforementioned metrics, the standard error of prediction, herein denoted as SE, specifies how far solutions by the AI-based recommendation system typically deviate from a regression model derived from said solutions. According to an embodiment, the regression model may be a regression line. According to some embodiments, SE may be calculated as follows:

$$SE = \sqrt{\frac{{Σ ( Y - {Y}^{′} )}^{2}}{N}}$$

Therein, values Y correspond to solutions by the AI-based recommendation system, values Y′ correspond to expected values provided by a regression model, and N corresponds to the number of values contained in Y and Y′, respectively.

The standard error of prediction provides a measure of uncertainty u:

u=SE

In order to obtain a measure of confidence c that a solution provided by the AI-based system is correct, a reciprocal of the standard error of prediction may be calculated.

$$c = \frac{1}{S E}$$

According to an embodiment, in order to obtain the aggregated quality indicator for each scoring batch, the quality indicator derived from said scoring batch is aggregated by calculating any one of a mean of the quality indicators and an interquartile range of the quality indicators. This may have the advantage that a single value can be derived from multiple quality indicators which summarizes an overall quality of recommendations contained within a scoring batch. The quality indicators may be aggregated in various ways. According to an embodiment, a mean may be calculated from the quality indicators in order to obtain the aggregated quality indicator. In particular, an arithmetic mean may be calculated from the quality indicators. Alternatively, an interquartile range may be calculated from the quality indicators. In order to calculate the interquartile range, the quality indicators may be ordered by their sizes, thereby obtaining an ordered set. Given a total of 2n items in the ordered set, the number of items being an even, or given a total of 2n+1 items in the ordered set, the number of items being odd, a first quartile Q₁ and a third quartile Q₂ are calculated, wherein Q₁ is the median of the n smallest values in the ordered set and Q₃ is the median of the n largest values in the ordered set. The interquartile range IQR is then calculated as:

IQR=Q₃−Q₁

According to some embodiments, the approach further comprises, if the quality indicators comprise multiple metrics, calculating the mean and/or the interquartile range separately for each metric in order to obtain the aggregated quality indicator. This may have the advantage that multiple metrics can be aggregated. According to an embodiment, the aggregated quality indicator contains multiple aggregated values, each aggregated value being calculated from a different type of metric. According to another embodiment, the aggregated quality indicator is only one value, which, according to some embodiments, may have been aggregated from different types of metrics.

According to some embodiments, the approach further comprises calculating the degree of correlation between the set of aggregated quality indicators and the set of business key performance indicators by calculating a Pearson correlation coefficient between the set of business key performance indicators and the set of aggregated quality indicators, and notifying the user of the AI-based recommendation system that recommendations by the AI-based recommendation system have been ignored if the Pearson correlation coefficient is bigger than −0.1 and smaller than 0.1. This may have the advantage that a problematic range of correlation can be consistently identified. The Pearson correlation coefficient is a measure of linear correlation between two variables. The degree of correlation is 0 if there is no linear correlation. Those knowledgeable in the art can implement the calculation of the Pearson correlation coefficient using the available literature on this topic.

For values between −0.1 and 0.1, there is a sufficiently small degree of correlation between the set of aggregated quality indicators and the set of business key performance indicators, indicating that the recommendations by the recommendation system are ignored. In the case that the recommendations by the AI-based recommendation system are observed, a higher degree of positive correlation or a higher degree of negative correlation are expected. For instance, if the aforementioned degree of confidence c in the recommendations by the AI-based recommendation system is generally high, then the business key performance indicators should indicate good results, on average. The aggregated quality indicators should therefore show a high degree of correlation with the business key performance indicators. If the degree of confidence c is low, then the business key performance indicators are expected to show inferior outcomes, on average. In this scenario, the aggregated quality indicators are also expected to show a high degree of correlation with the business key performance indicators. If, however, the degree of correlation is low, then this indicates that the recommendations are not being put into practice consistently.

According to some embodiments, the approach may further comprise calculating the degree of correlation between the set of aggregated quality indicators and the set of business key performance indicators by calculating a Kendall rank correlation coefficient or Spearman's rank correlation coefficient. This may have the advantage that alternative approaches for calculating the degree of correlation between the aggregated quality indicators and the business key performance indicators are provided. In some instances, using these correlation coefficients may yield more accurate results. The Kendall rank correlation coefficient provides a measure of rank correlation, as does Spearman's rank correlation coefficient. Either approach can be implemented by those knowledgeable in the art using the available literature on this topic.

According to some embodiments, the business key performance indicators from the set of business key performance indicators characterize a business performance of the business process during disjoint time periods, each time period being associated with one scoring batch from the set of scoring batches. Therefore, each business key performance indicator characterizes a business performance influenced by recommendations stored in scoring payload records contained within one particular scoring batch. This may have the advantage that a relationship is established between scoring batches and the business performance during certain time periods. According to an embodiment, each business key performance indicator describes a business performance during one of the disjoint time periods. According to an embodiment, the disjoint time periods are of equal length. For instance, the disjoint time periods may each encompass a separate day of the week, and each day of the week may be associated with a business key performance indicator which provides an estimate for a business performance on that particular day.

According to some embodiments, the approach may further comprise calculating the set of business key performance indicators by collecting performance data values related to the business process and calculating the set of business key performance indicators from the performance data values. This may have the advantage that business key performance indicators are calculated from performance data values. The business key performance indicator provides a means for estimating a business performance. According to an embodiment, each business key performance indicator may be calculated from performance data values contained in one business batch. For instance, each business batch may contain performance data values from a separate day. The business key performance indicator may be based on various data related to the business process. According to embodiments, the performance data values may be values selected from the group comprising: gross profit margin, net profit margin, return on equity, monthly recurring revenue, current ratio, revenue per customer, revenue growth rate, asset turnover rate, social media mentions and sales cycle length. Other performance data values may be used for calculating the business key performance indicators, as well. According to an embodiment, the performance data values used for calculating the business key performance indicators are stored in the scoring payload records. According to another embodiment, the performance data values used for calculating the business key performance indicators are stored in business payload records. According to embodiments, the business payload records may be stored within a database of business records. According to some embodiments, the business payload records are stored by a business process management engine. According to other embodiments, the performance data values may be obtained from other sources.

According to some embodiments, the approach further comprises, if the degree of correlation between the set of business key performance indicators and the set of aggregated quality indicators is within the predefined range, making available to the user via a graphical user interface the scoring payload records and/or performance data values related to the business process in order to allow the user to identify recommendations by the AI-based recommendation system which have been ignored. This may have the advantage that it allows a user to identify recommendations which have been ignored. By the help of the graphical user interface, this process is very convenient. According to embodiments, data from scoring payload records and/or performance data values may be visualized by means of tables, node diagrams, data flow diagrams, or other types of diagrams. Such data may also be displayed in any other conceivable manner. According to some embodiments, the graphical user interface may be interactive. It is possible that coloring is used in order to highlight critical results.

According to some embodiments, the approach may further comprise selecting a conspicuous business key performance indicator which deviates from other business key performance indicators from the set of business key performance indicators, and presenting to the user via the graphical user interface a set of scoring payload records from a scoring batch that the conspicuous business key performance indicator is associated with. This approach may have the advantage that it can help the user identify recommendations which have been ignored by displaying associated scoring payload records. The conspicuous business key performance indicator which is selected deviates from the other business key performance indicators because recommendations by the AI-based recommendation system have not been observed. According to some embodiments, more than one conspicuous business key performance indicator may be selected. The user may inspect the set of scoring payload records in order to identify recommendations by the AI-based recommendation system which have been ignored.

For instance, in the case that a business key performance indicator summarizing a business performance of a certain day deviates from other business key performance indicators, a scoring batch containing scoring payload records from that same day may be inspected. According to embodiments, the scoring payload records may allow the user to view recommendations by the AI-based recommendation system and/or metrics associated with these recommendations, for instance a degree of confidence or a degree of uncertainty which estimates whether a recommendation is correct.

According to another embodiment, the approach further comprises selecting a conspicuous business key performance indicator which deviates from other business key performance indicators from the set of business key performance indicators, compiling a set of performance data values used to calculate the conspicuous business key performance indicator, selecting a predefined fraction of lowest or highest performance data values from the set of performance data values, and presenting to the user via the graphical user interface scoring payload records associated with said fraction of performance data values. This approach may have the advantage that it can help to identify scoring payload records which contain recommendations that have been ignored, especially in the case that the scoring payload records have not changed significantly. The conspicuous business key performance indicator which is selected deviates from the other business key performance indicators because recommendations by the AI-based recommendation system have been ignored.

According to some embodiments, more than one conspicuous business key performance indicator may be selected. According to some embodiments, performance data values may be selected from the group comprising: gross profit margin, net profit margin, return on equity, monthly recurring revenue, current ratio, revenue per customer, revenue growth rate, asset turnover rate, social media mentions and sales cycle length. According to other embodiments, other performance data values may be used to calculate the business key performance indicator. A predefined fraction of lowest or highest performance data values from the set of performance data values is selected. According to an embodiment, said fraction is 10%. Scoring payload records associated with the respective performance data values are then presented to the user via the graphical user interface.

According to embodiments, a scoring payload record is considered to be associated with a performance data value if there exists a link between the scoring payload record and the performance data value. Such a link may be defined in a database or the like. According to embodiments, the link may be established manually, for instance by a user. According to other embodiments, said link may be established automatically. For instance, a performance data value may be linked to a scoring payload record if there is a cause-effect relationship between a recommendation from the scoring payload record and the performance data value.

According to embodiments, the approach may further comprise selecting a conspicuous aggregated quality indicator which deviates from other aggregated quality indicators from the set of aggregated quality indicators, selecting a predefined fraction of scoring payload records from a scoring batch associated with the conspicuous aggregated quality indicator containing either lowest or highest quality indicators from said scoring batch, and presenting to the user via the graphical user interface performance data values associated with the fraction of scoring payload records. This approach may have the advantage that it can help to identify performance data values resulting from recommendations which have been ignored, especially in the case that the performance data values do not exhibit any significant changes. Therefore, an aggregated quality indicator is identified which deviates from other aggregated quality indicators. According to some embodiments, more than one aggregated quality indicator may be selected. A fraction of scoring payload records is selected which contains either lowest or highest quality indicators. For instance, 10% of the scoring payload records may be selected from the scoring batch, the scoring payload records being either scoring payload records containing the lowest or the highest quality indicators to be found within the scoring batch. Each quality indicator may be derived from a metric, for instance a degree of confidence or a degree of uncertainty that a recommendation by the AI-based recommendation system is correct.

Performance data values associated with said scoring payload records are then identified and presented to the user via a graphical user interface. According to embodiments, a performance data value is considered to be associated with a scoring payload record if there exists a link between the performance data value and the scoring payload record. Such a link may be defined in a database or the like. According to embodiments, the link may be established manually, for instance by a user. According to other embodiments, said link may be established automatically. For instance, a performance data value may be linked to a scoring payload record if there is a cause-effect relationship between a recommendation from the scoring payload record and the performance data value.

With reference to the embodiments described above, in order to identify the conspicuous business key performance indicator which deviates from other business key performance indicators from the set of business key performance indicators, or to identify the conspicuous aggregated quality indicator which deviates from other aggregated quality indicators from the set of aggregated quality indicators, it has to be determined whether there is a sufficient degree of deviation. Various methods may be used in order to determine whether there is a sufficient degree of deviation. According to an embodiment, business key performance indicators or aggregated quality indicators may be qualified as conspicuous if they fall outside of a predefined numeric range. According to other embodiments, business key performance indicators or aggregated quality indicators may be qualified as conspicuous if they fall outside a predefined confidence interval.

Again with reference to the embodiments described above, the performance data values may be stored in business payload records. The business payload records may originate from the same database or system as the scoring payload records. It is also possible that they originate from another database or system. According to other embodiments, the performance data values may be stored within the scoring payload records. According to some embodiments, each scoring payload record contains a link identifying a business payload record or performance data value which measures an outcome of an action taken in response to a recommendation stored in said scoring payload record. For instance, if a scoring payload record stores a recommended value for an insurance premium, then by help of a link, a business payload record can be directly identified which stores an actual value chosen as the insurance premium. Therefore, the user can easily deduce whether recommendations by the AI-based recommendation system have been ignored.

An embodiment of the invention also relates to a computing system capable of detecting whether recommendations by an AI-based recommendation system for a business process have been ignored, the computing system being configured to implement the method as described above. According to embodiments of the computing system, all the actions of the method as described above can be implemented by the computing system in arbitrary combinations. According to some embodiments, the computing system may comprise an AI-based recommendation system, a detection system and a business process management engine. The AI-based recommendation system may be configured to provide recommendations regarding a business process. The detection system may be configured to detect whether recommendations provided by the AI-based recommendation system have been ignored. The business process management engine may be configured to help to control and/or supervise a business process. According to other embodiments, the computing system may comprise only two or only one of the components AI-based recommendation system, detection system and business process management engine.

Embodiments of the invention also relate to a computer program product for operating a computing system capable of detecting whether recommendations by an AI-based recommendation system for a business process have been ignored, the computer program product being configured to cause the computing system to perform the method as described above. According to embodiments of the computer program product, all the actions of the method as described above can be effected by the computer program product in arbitrary combinations.

In another aspect, embodiments of the invention relate to a detection system capable of detecting whether recommendations by an AI-based recommendation system for a business process have been ignored. The detection system implements aspects of the computing system described above. According to embodiments, the detection system is capable of interacting with the AI-based recommendation system and the business process management engine as described above, however it can also be employed in other contexts. The detection system can notify a user of an AI-based recommendation system that recommendations by the AI-based recommendation system have been ignored.

Embodiments of the invention also relate to an approach for providing computer-aided assistance for a business process. The approach comprises providing an AI-based recommendation system and providing a detection system. The AI-based recommendation system receives system input data characterizing the business process. According to some embodiments, the system input data may be provided by a business process management engine. The business process management engine may be configured to supervise, and, according to some embodiments, to control a business process or at least some aspects of a business process. The approach further comprises generating by the AI-based recommendation system recommendations for the business process based upon the input data characterizing the business process. The detection system loads a set of scoring batches from the AI-based recommendation system, each scoring batch containing multiple scoring payload records, the scoring payload records storing input data provided to the AI-based recommendation system and recommendation data provided by the AI-based recommendation system in response to the input data. For each scoring batch from the set of scoring batches, the detection system derives quality indicators from the scoring payload records, aggregates said quality indicators to obtain an aggregated quality indicator, the aggregated quality indicator specifying an estimated quality of recommendations by the AI-based recommendation system for said scoring batch, and adds the aggregated quality indicator to a set of aggregated quality indicators. The detection system also receives a set of business key performance indicators. According to some embodiments, the detection system may receive the set of business key performance indicators from the business process management engine. The approach further comprises calculating by the detection system a degree of correlation between the set of aggregated quality indicators and the set of business key performance indicators, and, if the degree of correlation between the set of business key performance indicators and the set of aggregated quality indicators is within a predefined range, notifying by the detection system a user of the AI-based recommendation system that recommendations by the AI-based recommendation system have been ignored. This approach has the advantage of providing an AI-based recommendation system and a detection system, wherein the detection system notifies the user if recommendations by the AI-based recommendation system have been ignored.

According to some embodiments, the AI-based recommendation system is a question answering computing system. This may have the advantage that the AI-based recommendation system can flexibly provide recommendations given different types of input data. A question answering computing system provides answers in response to questions. In this context, the question answering computing system may also provide recommendations. According to some embodiments, the question answering computing system is able to process questions asked in a natural language, such as English or any other language. According to some embodiments, the question answering system can reply to question in natural language, such as English or any other language. According to some embodiments, the question answering computing system is configured to receive inputs from a business process management engine and is further configured to provide business advice. For this purpose, the question answering computing system may be configured to provide answers to classification problems and/or regression problems.

According to an embodiment, the AI-based recommendation system employs machine learning. This may have the advantage that the AI-based recommendation can continuously extend its knowledge via training. According to embodiments, the AI-based recommendation system may employ at least one approach from the group consisting of artificial neural networks, decision trees, support vector machines, regression analysis, Bayesian networks and genetic algorithms. Other approaches may be employed, as well.

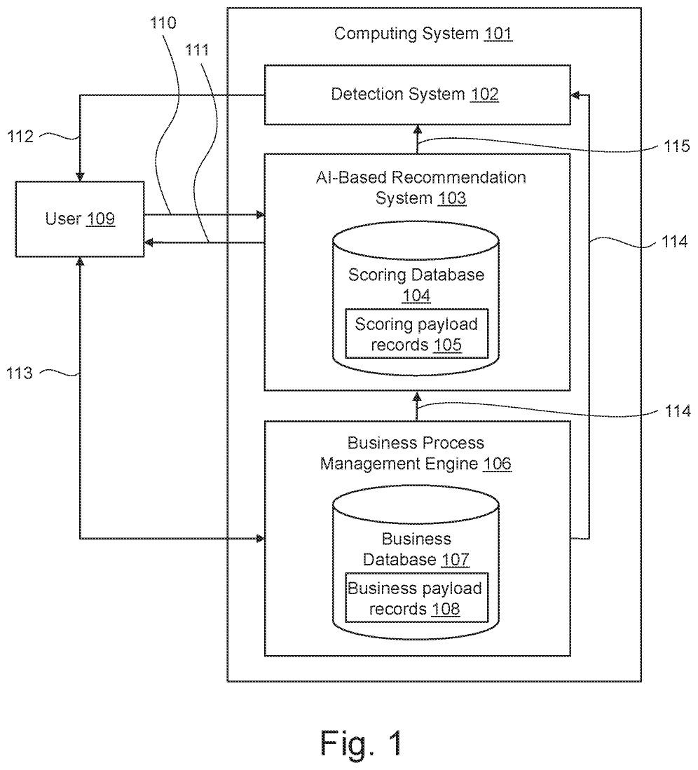

FIG. 1 depicts a block diagram featuring a computing system 101. The computing system 101 comprises an AI-based recommendation system 103 and a detection system 102. The AI-based recommendation system 103 is a question answering computing system which provides recommendations for a business process. The detection system 102 has the purpose of determining whether the recommendations 111 from the AI-based recommendation system 103 are being followed consistently. According to the present example, a business process management engine 106 is present which helps to control the business process. According to other examples, no business process management engine 106 may be present. Exemplarily, the detection system 102, the AI-based recommendation system 103 and the business process management engine 106 are part of the computing system 101, which may be a single computer workstation, a collection of computer workstations, or a cloud-based system. According to the present example, the AI-based recommendation system receives recommendation requests 110 from a user 109. In response, the AI-based recommendation system 103 provides recommendations 111.

The detection system 102 may send a notification 112 to the user 109 if it is has detected that recommendations 111 have not been observed. Business data 113 may be transferred between the user 109 and the business process management engine 106. The AI-based recommendation system 103 may for instance contain a scoring database 104 which contains multiple scoring payload records 105. Each scoring payload record 105 may contain various metrics related to a recommendation 111 by the AI-based recommendation system 103. From such metrics, the detection system 102 can derive quality indicators estimating whether recommendations 111 are correct. The business process management engine 106 contains a business database 107 containing business payload records 108. Each business payload record 108 contains one or more performance data values related to the business process. According to some examples, the business payload records 108 may be received as input data 114 by the AI-based recommendation system 103. The input data 114 may also include business key performance indicators, which, being calculated from the performance data values, indicate a performance of the business process as a whole. The AI-based recommendation system 103 uses the input data 114 as a basis for making its recommendations 111. As depicted, the detection system 102 may also receive the input data 114. In addition, the detection system 102 may receive detection data 115 from the AI-based recommendation system 103, wherein the detection data 115 comprises data from the scoring payload records 105. This allows the detection system 102 to evaluate whether the recommendations by the AI-based recommendation system 103 have been observed.

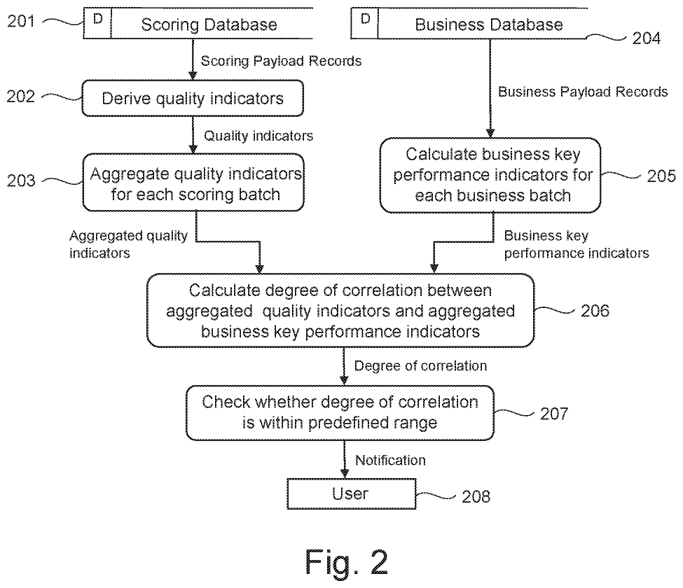

FIG. 2 depicts a data flow diagram illustrating how data from a scoring database 201 and a business database 204 may be processed and correlated according to embodiments of the present invention. The scoring database 201 contains multiple scoring payload records associated with recommendations provided by the AI-based recommendation system. Quality indicators are derived from the scoring payload records (202). Multiple scoring payload records may be grouped in so-called scoring batches. For instance, each scoring batch may contain scoring payload records from a separate day. For each scoring batch, quality indicators derived from scoring payload records from that scoring batch are aggregated (203), yielding an aggregated quality indicator for each scoring batch.

The business database 204 contains multiple business payload records, specifying various properties of the business process. Business payload records may be grouped in business batches. For instance, each business batch may contain business payload records from a certain day. For each business batch, a business key performance indicator is calculated (205), using performance data values from the business payload records contained within that business batch. Therefore, according to this example, an aggregated quality indicator and a business key performance indicator are obtained for each day. A degree of correlation between the aggregated quality indicators and the aggregated business key performance indicators is then calculated (206). The detection system checks whether the degree of correlation is within a predefined range (207). If this is the case, a notification that recommendations by the AI-based recommendation system have been ignored is sent by the recommendation system to the user 208.

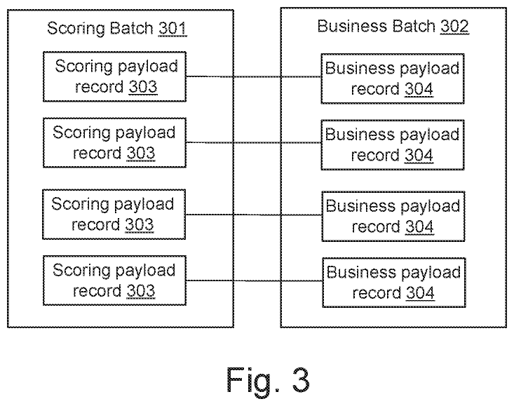

FIG. 3 depicts a block diagram illustrating scoring batches 301 and business batches 302. As mentioned above, each scoring database may contain multiple scoring payload records 303. Multiple scoring payload records 303 are grouped into one scoring batch 301. There can be multiple scoring batches 301, for instance one for each day. Likewise, each business database may contain multiple business payload records 304. These may be grouped into business batches 302. There can be multiple business batches, for instance one for each day. Each scoring payload record 303 may be linked to a business payload record 304. According to this example, each scoring payload record 303 contains data related to a recommendation made by the AI-based recommendation system. Each scoring payload record 303 is linked to a business payload record 304, that business payload record 304 containing business data which is dependent on the recommendation specified in the scoring payload record 303. For instance, a scoring payload record 303 may contain a recommendation regarding a selling price and a corresponding business payload record 304 may contain business data values relating to revenue and customer retention, which may change when selling prices are changed.

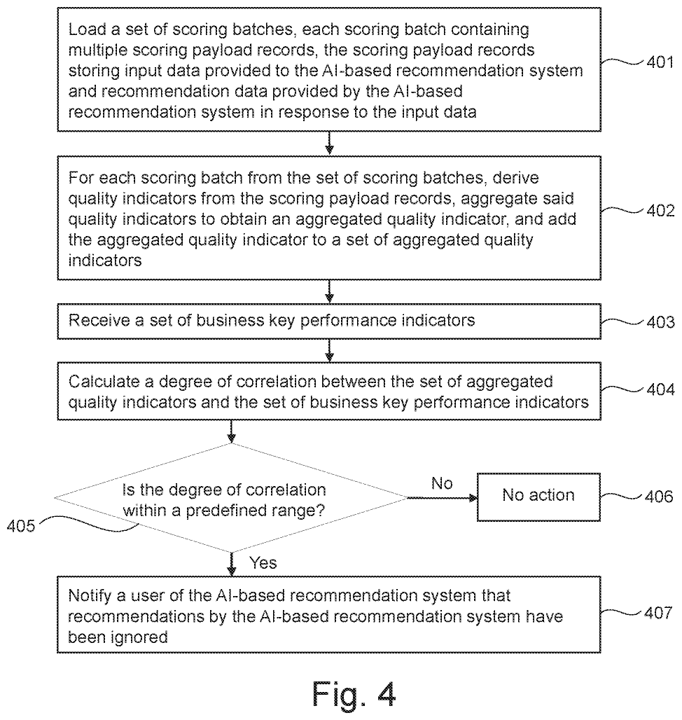

FIG. 4 depicts a flowchart detailing the operation of the computing system. The detection system within the computing system loads a set of scoring batches, each scoring batch containing multiple scoring payload records, the scoring payload records storing input data provided to the AI-based recommendation system and recommendation data provided by the AI-based recommendation system in response to the input data (401). According to the present example, each scoring batch contains scoring payload records from a separate day. For each scoring batch from the set of scoring batches, the detection system derives quality indicators from the scoring payload records, aggregates said quality indicators to obtain an aggregated quality indicator, and adds the aggregated quality indicator to a set of aggregated quality indicators (402). In order to derive the quality indicators from the scoring payload records, the detection system may for instance use as a metric a greatest probability of correctness stored by the scoring payload record, in the case that the AI-based recommendation system answers a classification problem. Other metrics may be used, as well. According to the present example, the quality indicators are aggregated by calculating their arithmetic mean. Furthermore, the detection system receives a set of business key performance indicators from the business process management engine (403). Beforehand, the business key performance indicators have been calculated from performance data values by the business process management engine as has been described with reference to FIG. 2.

Subsequently, the detection system calculates a degree of correlation between the set of aggregated quality indicators and the set of business key performance indicators (404). According to the present example, the detection system calculates a Pearson correlation coefficient in order to obtain the degree of correlation. The detection system then checks whether the degree of correlation is within a predefined range (405). For instance, it may be checked whether the Pearson correlation coefficient is higher than −0.1 and lower than 0.1. If this is not the case, then no action has to be taken (406). If, however, the Pearson correlation coefficient falls within this range, then the detection system notifies a user of the AI-based recommendation system that recommendations by the AI-based recommendation system have been ignored (407).

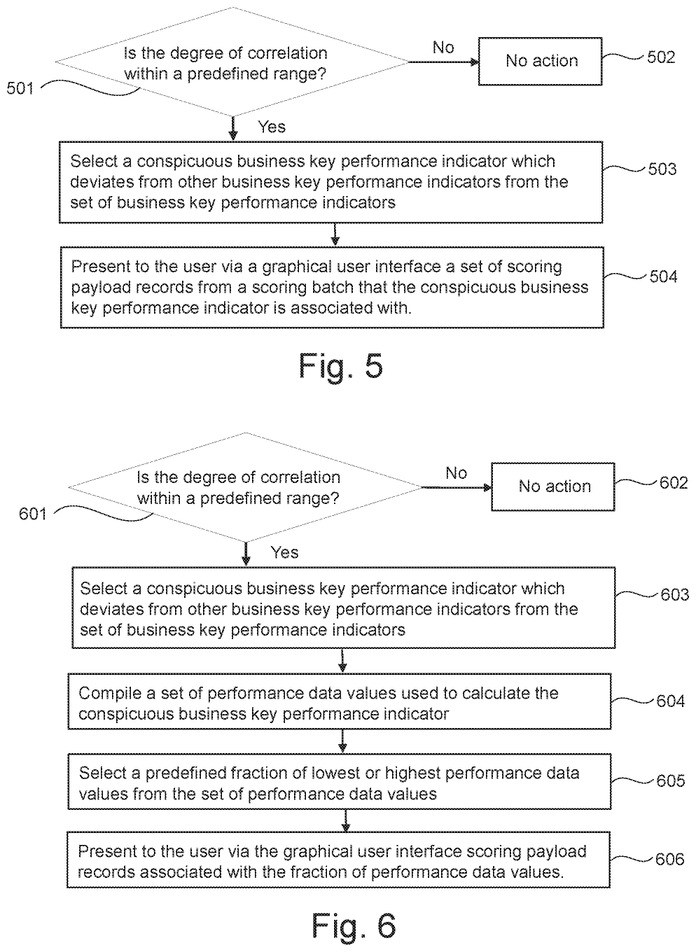

FIG. 5 depicts a flowchart detailing how scoring payload records containing recommendations which have been ignored can be identified via a graphical user interface. The detection system evaluates whether the degree of correlation is within the predefined range (501). If this is not the case, no further action has to be taken (502). If it is the case, this means that recommendations by the AI-based recommendation system have been ignored. The user may want to find scoring payload records which allow to identify the particular recommendations which have been ignored. For this purpose, the detection system selects a conspicuous business key performance indicator which deviates from other business key performance indicators from the set of business key performance indicators (503).

Preferably, the conspicuous business key performance indicator is selected by choosing a business key performance indicator from the set of business key performance indicators which is notably different from other business key performance indicators. For instance, a business key performance indicator which is a lot higher or lower than other business key performance indicators from the set of business key performance indicators may be chosen. As an example, a business key performance indicator may exhibit a relatively low value due to a decreased business performance, which in turn may be due to the fact that a corresponding recommendation by the AI-based recommendation system has been ignored.

The detection system then presents to the user via a graphical user interface a set of scoring payload records from a scoring batch that the conspicuous business key performance indicator is associated with (504). The scoring batch that the conspicuous business key performance indicator is associated with contains information related to recommendations which may have caused the business key performance indicator to deviate. For instance, given conspicuous key business key performance indicator that indicates the business performance on a particular day, a scoring batch containing scoring payload records from that particular day will be selected. The user may then browse these scoring payload records, which are likely to include recommendations which have been ignored.

FIG. 6 depicts a flowchart detailing an alternate approach for identifying via a graphical user interface scoring payload records containing recommendations which have been ignored. The detection system evaluates whether the degree of correlation is within the predefined range (601). If this is not the case, no further action has to be taken (602). If it is the case, this means that recommendations by the AI-based recommendation system have been ignored. The user may want to identify scoring payload records related to recommendations which have been ignored. The detection system selects a conspicuous business key performance indicator which deviates from other business key performance indicators from the set of business key performance indicators (603). A conspicuous business key performance indicator may be selected in the same manner as described above with regard to FIG. 5. The detection system may then compile a set of performance data values used to calculate the conspicuous business key performance indicator (604). The performance data values may be taken from business scoring records.

The detection system selects a predefined fraction of lowest or highest performance data values from the batch of performance data values (605). For instance, the detection system may select 10% of the performance data values, selecting only the lowest performance data values. Because the business performance values are particularly low, they may be indicative of an unfavorable business performance, due to the fact that corresponding recommendations by the AI-based recommendation system have been ignored. The detection system then presents to the user via the graphical user interface scoring payload records associated with the fraction of performance data values (606). Said scoring payload records are associated with the performance data values because they have been predefined to be linked to these performance data values. For example, a scoring payload record which recommends a selling price may be linked to a performance data value which represents product sales. The user may browse the presented scoring payload records via the graphical user interface in order to discover recommendations which have been ignored.

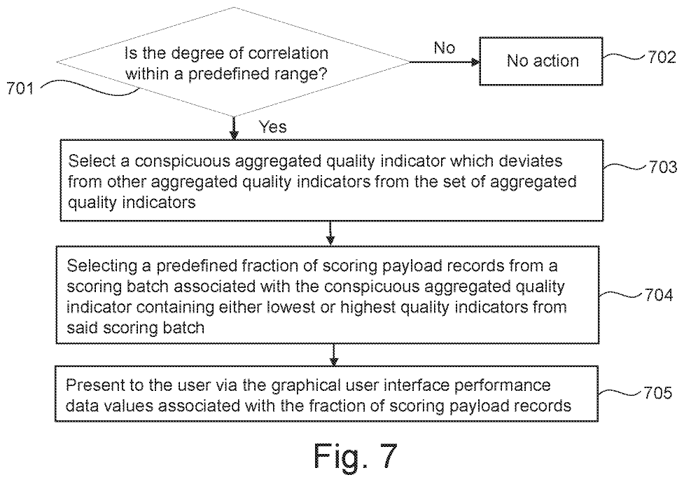

FIG. 7 depicts a flowchart detailing how performance data values related to recommendations which have been ignored can be identified via a graphical user interface. The detection system evaluates whether the degree of correlation is within the predefined range (701). If this is not the case, no further action has to be taken (702). If it is the case, this means that recommendations by the AI-based recommendation system have been ignored. The user may want to identify performance data values related to recommendations which have been ignored. The detection system selects a conspicuous aggregated quality indicator which deviates from other aggregated quality indicators from the set of aggregated quality indicators (703). Preferably, the conspicuous aggregated quality indicator is selected by choosing an aggregated quality indicator from the set of aggregated quality indicators which is notably different from the other aggregated quality indicators. For instance, the selected aggregated quality indicator may be a lot higher or lower than other aggregated quality indicators from the set of aggregated quality indicators.

The detection system then selects a predefined fraction of scoring payload records from a scoring batch associated with the conspicuous aggregated quality indicator containing either lowest or highest quality indicators from said scoring batch (704). For instance, 10% of the scoring payload records may be selected which indicate a particularly high degree of confidence in recommendations stored within the respective scoring payload records. The detection system then presents to the user via the graphical user interface performance data values associated with the fraction of scoring payload records (705). Said performance data values are associated with the scoring payload records because they have been predefined to be linked to these performance data values. For example, a scoring payload record which recommends a selling price may be linked to a performance data value which represents product sales. The user may browse the performance data values via the graphical user interface in order to discover recommendations which have been ignored.

Embodiments of the present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
loading, by one or more processors, a set of scoring batches, each scoring batch containing multiple scoring payload records, the scoring payload records storing input data provided to an artificial intelligence (AI) based recommendation system in response to the input data;
deriving, by one or more processors, quality indicators for each scoring batch from the scoring payload records;
aggregating, by one or more processors, the quality indicators to obtain an aggregated quality indicator, wherein the aggregated quality indicator specifies an estimated quality of recommendations by the AI-based recommendation system for each respective scoring batch;
adding, by one or more processors, the aggregated quality indicator to a set of aggregated quality indicators;
calculating, by one or more processors, a key performance indicator for each scoring batch;
adding, by one or more processors, the key performance indicator to a set of key performance indicators;
determining, by one or more processors, that a degree of correlation between the set of aggregated quality indicators and the set of key performance indicators is within a predefined range; and
responsive to the degree of correlation being within the predefined range, generating a notification that the AI-based recommendation system has been ignored.

2. The method of claim 1, wherein:
each scoring payload record stores: (i) multiple classes and (ii) a probability of correctness of each class; and
the AI-based recommendation system answers classification problems.

3. The method of claim 2, wherein:
each quality indicator is derived by assembling at least one metric selected from the group consisting of: a greatest probability of correctness stored by the scoring payload record; one subtracted by a difference between the greatest probability of correctness stored by the scoring payload record and a second greatest probability of correctness stored by the scoring payload record; one subtracted by a difference between the greatest probability of correctness stored by the scoring payload record and an average of all other probabilities of correctness stored by the scoring payload record; and a minimum number of probabilities of correctness stored by the scoring payload record that, when added up, surpass a predefined prediction interval.

4. The method of claim 1, wherein the AI-based recommendation system answers regression problems.

5. The method of claim 4, wherein each quality indicator is derived by assembling at least one metric selected from the group consisting of: a difference between an upper bound and a lower bound of a prediction interval stored by the scoring payload record; a reciprocal of the difference between the upper bound and the lower bound of the prediction interval stored by the scoring payload record; a standard error of prediction stored by the scoring payload record; and a reciprocal of the standard error of prediction stored by the scoring payload record.

6. The method of claim 1, further comprising:
aggregating, by one or more processors, the quality indicators by calculating a selection from the group consisting of: a mean of the quality indicators; and an interquartile range of the quality indicators.

7. The method of claim 6, further comprising:
responsive to the quality indicators comprising multiple metrics, calculating, by one or more processors, a selection from the group consisting of: the mean separately for each metric; and the interquartile range separately for each metric.

8. The method of claim 1, further comprising:
calculating, by one or more processors, the degree of correlation by calculating a Pearson correlation coefficient between the set of key performance indicators and the set of aggregated quality indicators; and
wherein the predefined range is a Pearson correlation coefficient larger than −0.1 and smaller than 0.1.

9. The method of claim 1, further comprising:
calculating, by one or more processors, the degree of correlation by calculating a selection from the group consisting of: a Kendall rank correlation coefficient; and a Spearman's rank correlation coefficient.

10. The method of claim 1, wherein the key performance indicators characterize a performance of a process during disjoint time periods, each time period being associated with one scoring batch from the set of scoring batches.

11. The method of claim 1, wherein calculating the key performance indicator comprises:
collecting, by one or more processors, performance data values related to a process; and
calculating, by one or more processors, the key performance indicator based on the performance data values.

12. The method of claim 1, wherein generating the notification further comprises making available, to a user via a graphical user interface, the scoring payload records and performance data values related to a process.

13. The method of claim 12, further comprising:
selecting, by one or more processors, a first key performance indicator which deviates from other key performance indicators from the set of key performance indicators, and
presenting, by one or more processors, to the user via the graphical user interface, a set of scoring payload records from a scoring batch that the first key performance indicator is associated with.

14. The method of claim 12, further comprising:
selecting, by one or more processors, a first key performance indicator which deviates from other key performance indicators from the set of key performance indicators;
compiling, by one or more processors, a set of performance data values used to calculate the first business key performance indicator;
selecting, by one or more processors, a predefined fraction of lowest performance data values from the set of performance data values; and
presenting, by one or more processors, to the user via the graphical user interface, scoring payload records associated with the fraction of performance data values.

15. The method of claim 12, further comprising:
selecting, by one or more processors, a first aggregated quality indicator which deviates from other aggregated quality indicators from the set of aggregated quality indicators;
selecting, by one or more processors, a predefined fraction of scoring payload records from a scoring batch associated with the first aggregated quality indicator containing lowest quality indicators from said scoring batch; and
presenting, by one or more processors, to the user via the graphical user interface, performance data values associated with the fraction of scoring payload records.

16. A computer program product comprising:
one or more computer readable storage media, and program instructions collectively stored on the one or more computer readable storage media, the program instructions comprising:
program instructions to load a set of scoring batches, each scoring batch containing multiple scoring payload records, the scoring payload records storing input data provided to an artificial intelligence (AI) based recommendation system in response to the input data;
program instructions to derive quality indicators for each scoring batch from the scoring payload records;
program instructions to aggregate the quality indicators to obtain an aggregated quality indicator, wherein the aggregated quality indicator specifies an estimated quality of recommendations by the AI-based recommendation system for each respective scoring batch;
program instructions to add the aggregated quality indicator to a set of aggregated quality indicators;
program instructions to calculate a key performance indicator for each scoring batch;
program instructions to add the key performance indicator to a set of key performance indicators;
program instructions to determine that a degree of correlation between the set of aggregated quality indicators and the set of key performance indicators is within a predefined range; and
program instructions to, responsive to the degree of correlation being within the predefined range, generate a notification that the AI-based recommendation system has been ignored.

17. The computer program product of claim 16, wherein:
each scoring payload record stores: (i) multiple classes and (ii) a probability of correctness of each class; and
the AI-based recommendation system answers classification problems.

18. The computer program product of claim 17, wherein:
each quality indicator is derived by assembling at least one metric selected from the group consisting of: a greatest probability of correctness stored by the scoring payload record; one subtracted by a difference between the greatest probability of correctness stored by the scoring payload record and a second greatest probability of correctness stored by the scoring payload record; one subtracted by a difference between the greatest probability of correctness stored by the scoring payload record and an average of all other probabilities of correctness stored by the scoring payload record; and a minimum number of probabilities of correctness stored by the scoring payload record that, when added up, surpass a predefined prediction interval.

19. The computer program product of claim 16, wherein the AI-based recommendation system answers regression problems.

20. A computer system comprising:
one or more computer processors, one or more computer readable storage media, and program instructions collectively stored on the one or more computer readable storage media for execution by at least one of the one or more computer processors, the program instructions comprising:
program instructions to load a set of scoring batches, each scoring batch containing multiple scoring payload records, the scoring payload records storing input data provided to an artificial intelligence (AI) based recommendation system in response to the input data;
program instructions to derive quality indicators for each scoring batch from the scoring payload records;
program instructions to aggregate the quality indicators to obtain an aggregated quality indicator, wherein the aggregated quality indicator specifies an estimated quality of recommendations by the AI-based recommendation system for each respective scoring batch;
program instructions to add the aggregated quality indicator to a set of aggregated quality indicators;
program instructions to calculate a key performance indicator for each scoring batch;
program instructions to add the key performance indicator to a set of key performance indicators;
program instructions to determine that a degree of correlation between the set of aggregated quality indicators and the set of key performance indicators is within a predefined range; and
program instructions to, responsive to the degree of correlation being within the predefined range, generate a notification that the AI-based recommendation system has been ignored.
